(19) United States
(12) Patent Application Publication
(10) Pub. No.: US 2006/0115338 A1
(43) Pub. Date: Jun. 1, 2006

(54) Method for making miniature tri-blade drill and structure of the same

(76) Inventor: Tsan-Zan Yam, Xinzhuang City (TW)

Correspondence Address: Tsan-Zan YAM, P.O. Box No. 6-57, Junghe, Taipei, 235, TW

(21) Appl. No.: 10/996,388

(22) Filed: Nov. 26, 2004

(51) Int. Cl. B23B 51/00

(52) U.S. Cl. 408/230

(57) ABSTRACT

The invention discloses a method for making a miniature tri-blade drill structure and a structure of the same, wherein the method includes steps of grinding a metal round post having appropriate dimensions into a raw material of a miniature drill; dividing the raw material into three equal parts, and grinding a drill body using a single grinding wheel to form three waste dismissing grooves having central lines located 120 degrees apart from one another; and grinding a tip of the raw material to form three cutting planes. A miniature tri-blade drill structure manufactured using the aforesaid method is capable of lowering production costs and effectively increasing quality of finished products.

### BACKGROUND OF THE INVENTION

(a) Field of the Invention

The invention relates to a method for making a miniature tri-blade drill and a structure of the same, and more particularly, to method for making a miniature tri-blade drill used for drilling operations of printed circuit boards and grinding a drill body to form three waste dismissing grooves and three cutting sections, thereby lowering production costs and effectively elevating quality of finished products.

(b) Description of the Prior Art

For that printed circuit boards are made by pressing two layers of glass fiber and epoxy substrates and sometimes with a copper foil in between, wherein epoxy accounts for about 70% of an overall volume and has a thermal deformation temperature ranging between 90° C. and 150° C. Thus, supposed a temperature during drilling operations in manufacturing process of printed circuit boards exceeds 150° C., drill waste is immediately melted and adhered to the drill and walls of the drilled hole—the drill waste is commonly referred to as glue dregs. An amount of glue dregs has a crucial effect on feasibility of subsequent manufacturing process. Average lifespan of a drill is about 1500 to 2000 cycles; wherein each cycle consists drilling one hole in 2 to 4 layers stacked within 3 to 10 minutes, has the drill drilling with a rotational speed at 100,000 to 200,000 RPM and a temperature at a front end thereof being as high as 300° C. to 500° C. All of the above further emphasizes on importance of dismiss of the drill waste. In addition, in order to target at a miniaturization trend of electronic products, a size of the drill is relatively reduced, meaning that position precision requirements of drill holes are significantly increased. Hence, locating properties and rigidity of the drill are also becoming even more vital.

Referring to FIG. 1A showing a prior drill for printed circuit board, the drill with a conventional twin-blade drill head a, although continuous modifications are made, still has drawbacks of likely deviated drilled holes, an easily broken drill body, and unsatisfactory quality of drilled walls that remain ineffectively solved. These drawbacks are incurred by the miniature twin-blade drill head a and are illustrated as below:

1. Rigidity and Waste Dismiss:

Referring to FIGS. 1A and 1B, a cross-section of a drill body b of the twin-blade drill head a appears as a long strip having two larger ends and a smaller middle section. Furthermore, for better waste dismiss, a thickness of the blade is necessarily thin leading to rigidity inadequacy of the drill body b. When a drill tip d is rotated and pierced into a board, in lack of sufficient rigidity of the drill body b, the drill tip d becomes prone to breakage or the drill body b is easily bent to cause deviated drilled holes.

2. Positioning:

Referring to FIGS. 2A, 2B and 2C, a central apex e of the miniature twin-blade drill a is an intersection point of two pairs of cutting planes a1 and waste dismissing planes a2. During manufacturing process, intersection lines of most drills heads do not have solid and fixed intersection points owing to minute common differences in a diameter of the drill body b, such that the two pairs of cutting planes a1 and waste dismissing a2 are overlapped or separated, and the central apex is not intersected at one point to further result in inexact positioning.

It is apparent from the description that, the prior miniature twin-blade drill head a has the aforesaid drawbacks. Also, according to a prior twin-blade drill, two pieces of grinding wheels are used to grind the drill body and the drill tip. However, the two pieces of grinding wheels may be concluded with different degrees of wear. Hence, not only quality of finished products using the drill head is undesirably affected, but also production costs are increased.

### SUMMARY OF THE INVENTION

In view of the aforementioned drawbacks of prior inventions, the primary object of the invention to provide a method for making a miniature tri-blade drill and a structure of the same, which are capable of lowering production costs as well as effective elevating quality of finished products.

The other object of the invention is to provide a miniature drill structure offering speedy cutting and waste dismissing effects as well as locating effects for stabilizing shapes of drilled holes and thus lengthening lifespan of the drill.

A method for making a miniature tri-blade drill and a structure of the same, wherein the method comprises steps of grinding a metal round post having appropriate dimensions into a raw material of a miniature drill; dividing the raw material into three equal parts, and grinding a drill body using a single grinding wheel to form three waste dismissing grooves having central lines located 120 degrees apart from one another; and grinding a tip of the raw material to form three cutting planes. The miniature tri-blade drill comprises a drill body and a drill handle, wherein the drill body has a tip thereof formed with three cutting planes, with a crest line formed by every two cutting planes and a cone point formed by the three crest lines come into junction. Each crest line has two sides thereof respectively formed with a cutting section and a waste dismissing groove.

According to the aforesaid steps, the invention utilizes a grinding wheel having an especially designed angle to grind the raw material. The miniature tri-blade drill formed by grinding has three cutting sections and enlarged waste dismissing spaces. Not only speeds of cutting and waste dismissing process are increased, but also a thickness of the drill body is reduced owing to the three waste dismissing grooves. Consequently, the present invention is free from a second grinding procedure of the drill body as in a prior miniature twin-blade drill in order to reduce friction, and does not need two grinding wheels having different angles as the prior art. Using two grinding wheels that have different degrees of wear, the prior miniature twin-blade drill wastes more time and is likely to produce finished products having unstable quality while also increasing production costs. Furthermore, the miniature tri-blade drill made by the method according to the invention has three cutting sections, which are located 120 degrees apart form one another and impose balancing and retaining effects on one another during when performing cutting operation in rotation. Influences on rigidity of the drill body are minimized and a drill tip of the invention is preventing from vibrations and swaying movements due to drag forces of cutting, and circularity drilled holes and quality of drilled walls are enhanced, with a cutting efficiency substantially elevated as well. Proven by practical tests, breakage in the drill body and deviation of drilled holes are reduced by at least 80%, meaning that lifespan of the drill is lengthened. A cross-section of the tri-blade drill appears as a tri-intersectional structure when view from the top. Reinforcement ribs are formed by a thickness between the cutting sections and the waste dismissing grooves form a trident structure to increase rigidity of the drill body. Also, the three cutting planes at a tip of the drill body is ground with a same angle, and the three crest lines formed by the three cutting planes are exactly intersected at a center of the drill body to form a cone point that is not variant by differences in a diameter of the drill body, thereby offering more accurate locating effects when the drill performs drilling operations. Above all, for that the cutting sections at the drill is located from the drill body at a same angle, a structure of a grinding mechanism can be substantially simplified, while also rendering more speedy and stable drilling operations unlike unsmooth and slow drilling operations using prior twin-blade drill having two cutting planes that drill with two different angles.

### BRIEF DESCRIPTION OF THE DRAWINGS

FIG. 1A shows a side view of a prior art.

FIG. 1B show a top view of a prior art.

FIG. 2A shows a first top view of a prior drill tip.

FIG. 2B shows a second top view of a prior drill tip.

FIG. 2C shows a third top view of a prior drill tip.

FIG. 3 shows a manufacturing process flow chart according to the invention.

FIG. 4 shows a side view according to the invention.

FIG. 5A shows a top view of a drill tip according to the invention.

FIG. 5B shows a side view of a drill body according to the invention.

FIG. 6A shows a first schematic view illustrating waste dismissing space according to the invention.

FIG. 6B shows a second schematic view illustrating waste dismissing space according to the invention.

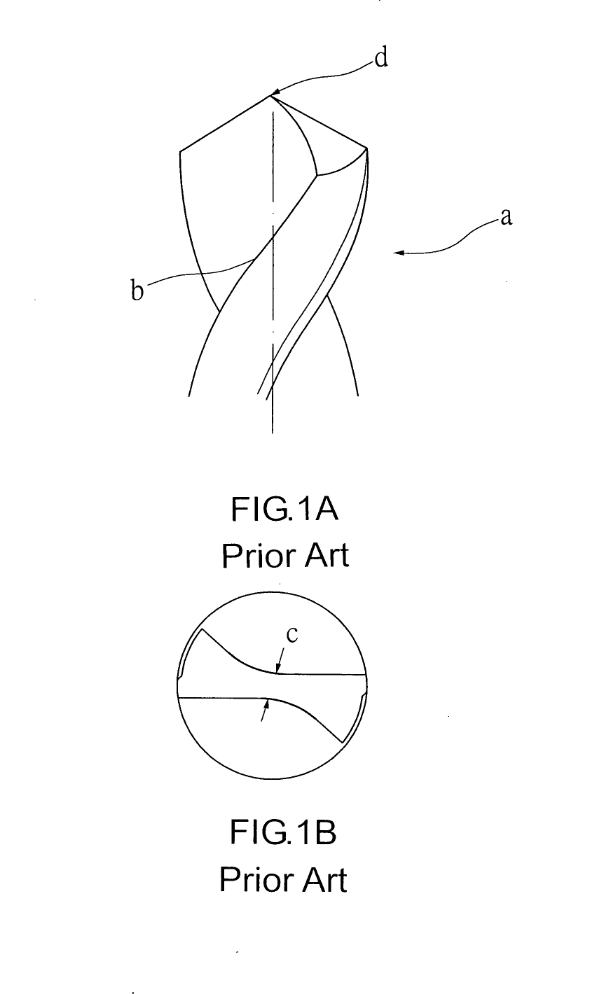

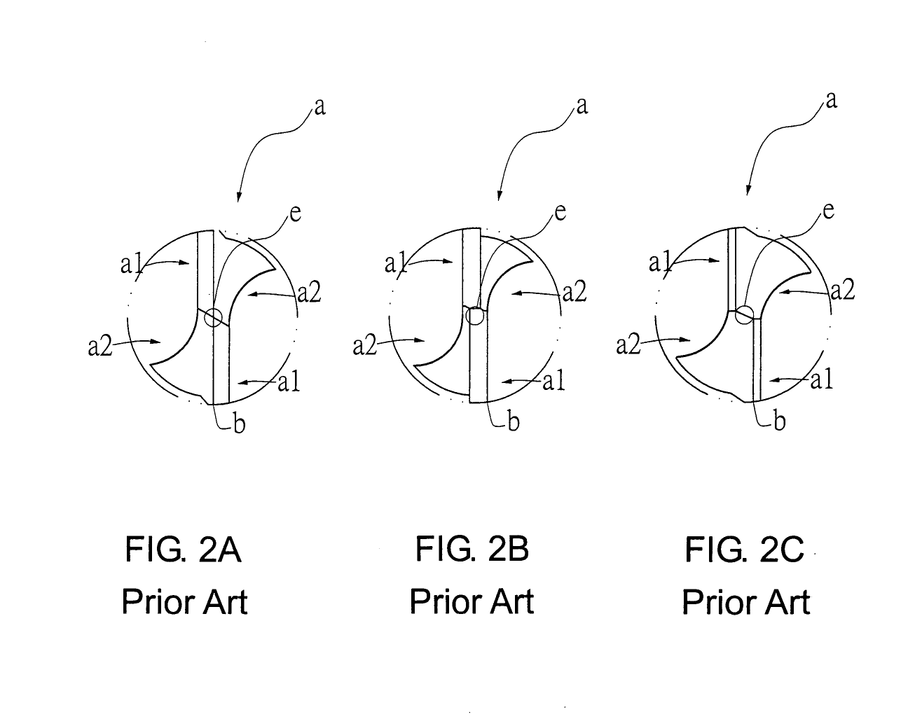

### DETAILED DESCRIPTION OF THE PREFERRED EMBODIMENTS

To better understand the invention, detailed descriptions shall be given with the accompanying drawings below.

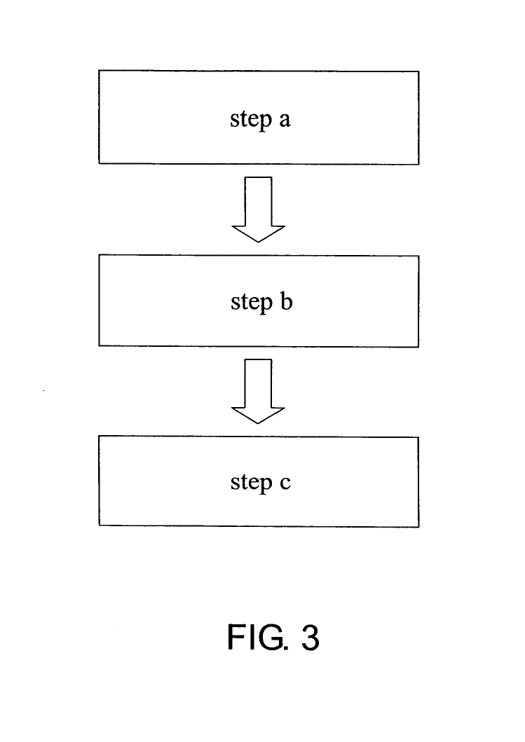

Referring to FIG. 3, a method for making a miniature tri-blade drill head according to the invention comprises steps of:
a. grinding a metal round post having appropriate dimensions into a raw material of a miniature drill;
b. dividing the raw material into three equal parts, and grinding a drill body using a single grinding wheel to form three waste dismissing grooves having central lines located 120 degrees apart from one another; and
c. grinding a tip of the raw material to form three cutting planes located 120 degrees apart from one another.

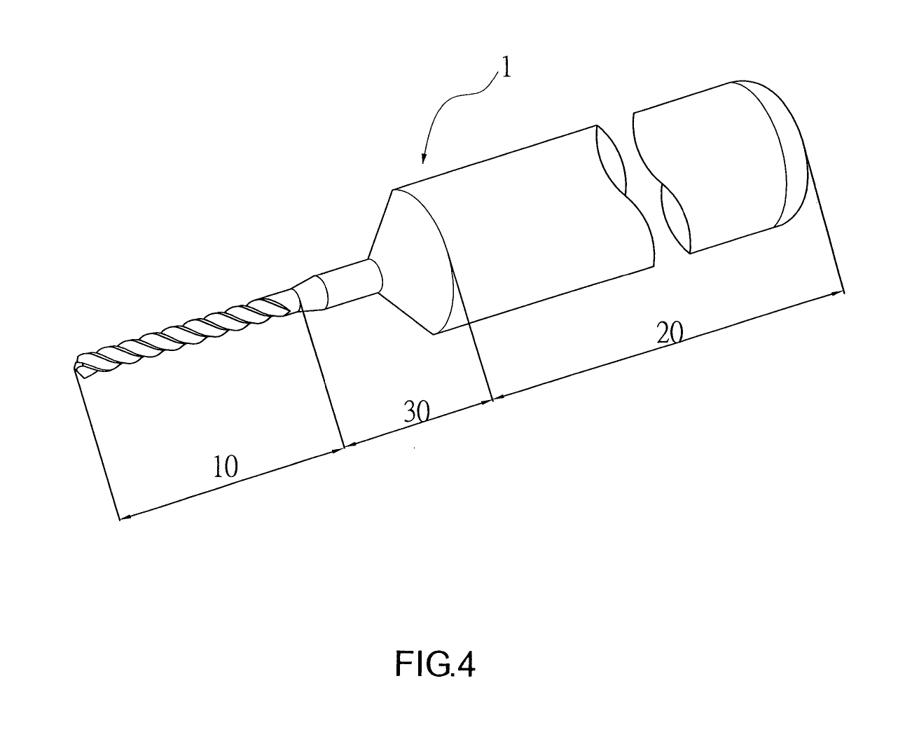

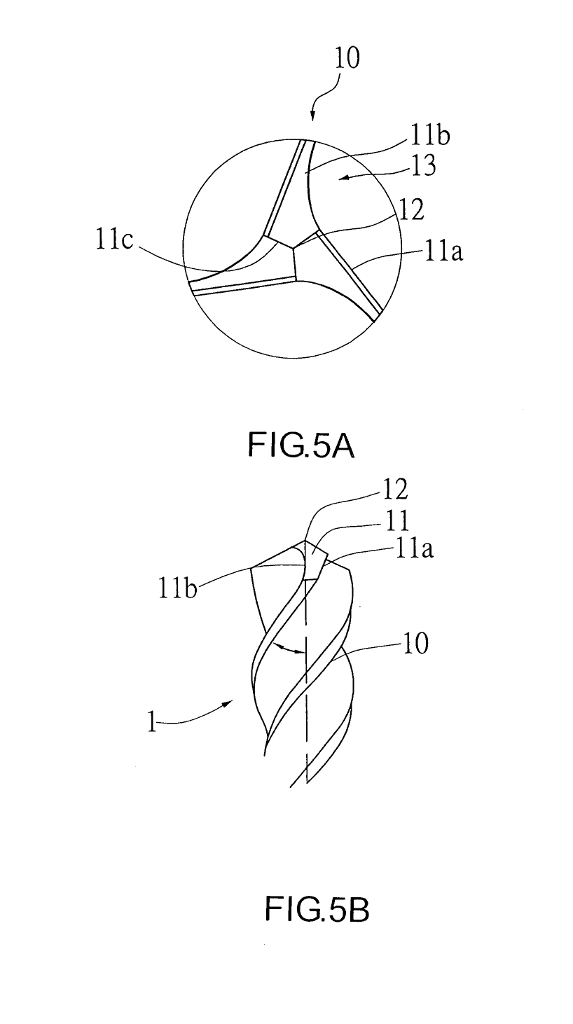

Referring to FIGS. 4, 5A and 5B, a miniature tri-blade drill 1 made a according to the aforesaid steps comprises a drill body 10 and a drill handle 20, wherein the drill body 10 is extended forward with a distance from the drill handle 20. The drill body and the drill handle have diameters that large differentiate and are in concentric circle forms, and hence an apparent two-sectional cone section 30 is connected between the drill body 10 and the drill handle 20 to serve as a buffer for absorbing the diameter difference. The drill body 10 has a tip thereof ground to form three cutting planes 11, with a crest line 11c formed by every two cutting planes 11 and a cone point 12 formed by three crest lines 11c come into junction. Each of the crest lines 11c has two sides thereof respectively formed with a cutting section 11a and a waste dismissing groove 11b, and a waste dismissing space 13 is formed between two opposite cutting section 11a and waste dismissing groove 11b.

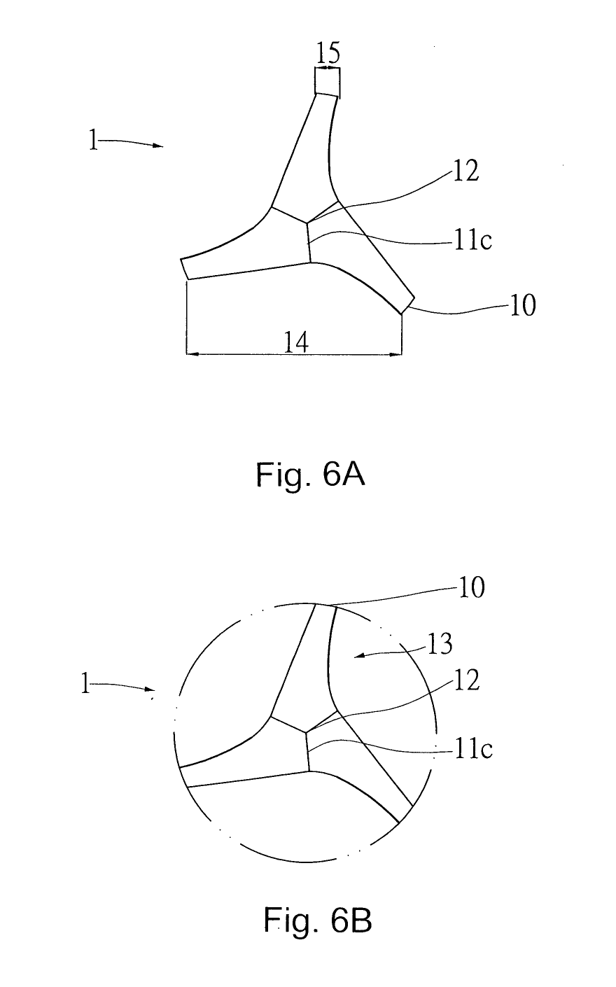

Referring to FIGS. 6A and 6B showing a schematic view illustrating a waste dismissing space of the miniature tri-blade drill according to the invention, the smaller a groove backside is, the greater a groove width 15 gets, and therefore the larger the waste dismissing spaces 13 becomes. However, as a result, a thickness of the cutting section 11a is reduced to lessen rigidity of the drill body or even lead to breakage of the miniature tri-blade drill 1. It is then essential that a shape of the grinding wheel and depths of the ground grooves be accurately controlled. The closer the cone point 12 approaches a center of the entire drill body 10, the better locating effects are provided. The cone point 12 is determined by the crest lines 11c formed by the three cutting planes 11, which are located 120 degrees apart from one another and balancing and impose retaining effects on one another. Hence, the drill 1 is prevented from vibrations and swaying movements due to drag forces of cutting, and circularity drilled holes and quality of drilled walls are enhanced. In addition, since the cutting planes 11 of the drill 1 is located from the drill body 10 at one angle only when performing drilling operations, a grinding mechanism can be substantially simplified to ensure even more speedy and stable grinding operations.

According practical implementation of the invention, the drill 1 manufactured using the following method accomplishes the most speedy cutting and waste dismissing effects. In the miniature tri-blade drill 1, the drill body 10 has a spiral angle θ being 20 to 45 degrees, the cutting sections 11a have a length thereof being 0.15 to 0.4 times of a diameter of the drill body 10, the drill tip crest lines 11c have a length thereof being 0.1 to 0.3 times of the diameter of the drill body 10, and the drill body 10 has a groove width thereof being 0.5 to 0.8 times of the diameter thereof and a groove backside width 14 being 0.1 to 0.3 times of the diameter thereof.

Conclusive from the above, the method for making a miniature tri-blade and a structure of the same according to the invention provides tri-blade cutting sections with larger waste dismissing spaces for speedily accomplishing cutting and waste dismissing effects. In addition, the three cutting sections are located 120 degrees apart from one another and impose balancing and retaining effects on one another, thereby lengthening lifespan of the drill as well as offering excellent locating effects and uniform shapes of drilled holes.

It is of course to be understood that the embodiment described herein is merely illustrative of the principles of the invention and that a wide variety of modifications thereto may be effected by persons skilled in the art without departing from the spirit and scope of the invention as set forth in the following claims.

What is claimed is:

1. A method for making a miniature tri-blade drill comprising steps of:
a. grinding a metal round post having appropriate dimensions into a raw material of a miniature drill;
b. dividing the raw material into three equal parts, and grinding a drill body using a single grinding wheel to form three waste dismissing grooves having central lines located 120 degrees apart from one another; and
c. grinding a tip of the raw material to form three cutting planes located 120 degrees apart from one another.

2. A miniature tri-blade drill structure comprising a drill body and a drill handle; wherein the drill body is for drilling holes at a printed circuit board and the drill handle is for locating to a drilling machine; and being characterized that, the drill body is extended forward with a distance from the drill handle; an apparent two-sectional cone section is connected between the drill body and the drill handle; the drill body has a tip thereof ground to form three cutting planes, with a crest line formed by every two cutting planes and a cone point formed by three crest lines come into junction.

3. The miniature tri-blade drill structure in accordance with claim 2, wherein a spiral angle of the drill body of the drill ranges between 20 and 45 degrees.

4. The miniature tri-blade drill structure in accordance with claim 2, wherein the cutting planes have a length 0.15 to 0.4 times of a diameter of the drill body.

5. The miniature tri-blade drill structure in accordance with claim 2, wherein the crest lines at the drill tip have a length 0.1 to 0.3 times of a diameter of the drill body.

6. The miniature tri-blade drill structure in accordance with claim 2, wherein a groove width of the drill body is 0.5 to 0.8 times of a diameter of the drill body.

7. The miniature tri-blade drill structure in accordance with claim 2, wherein a width of a backside groove is 0.1 to 0.3 times of a diameter of the drill body.
